(19) United States
(12) Patent Application Publication
(10) Pub. No.: US 2012/0132728 A1
(43) Pub. Date: May 31, 2012

(54) INJECTOR FOR VEHICLES

(75) Inventors: Minsu KIM, Hwasung-si (KR); Myung Jun Lee, Yongin-city (KR); Minyoung Ki, Seoul (KR)

(73) Assignee: Hyundai Motor Company, Seoul (KR)

(21) Appl. No.: 13/189,033

(22) Filed: Jul. 22, 2011

(30) Foreign Application Priority Data
Nov. 29, 2010 (KR) 10-2010-0119809

(51) Int. Cl. F02M 59/00

(52) U.S. Cl. 239/533.2; 222/559

(57) ABSTRACT

An injector for vehicles improves utilization rate of air and mixing rate of air and fuel by disposing first and second nozzle holes having different K factors alternately. The injector for vehicles may include a housing of cylindrical shape, a plurality of nozzle holes communicating an inside of the housing with an outside thereof at a lower end of the housing, and a needle adapted to move reciprocally in the housing, and selectively opening or closing the nozzle hole, wherein the plurality of nozzle holes has a plurality of K factors.

### CROSS-REFERENCE TO RELATED APPLICATION

This application claims priority to and the benefit of Korean Patent Application No. 10-2010-0119809 filed Nov. 29, 2010, the entire contents of which application is incorporated herein for all purposes by this reference.

### BACKGROUND OF INVENTION

1. Field of Invention

The present invention relates to an injector for vehicles. More particularly, the present invention relates to an injector for vehicles that improves utilization rate of air and mixing rate of air and fuel by disposing first and second nozzle holes having different K factors alternately.

2. Description of Related Art

Generally, vehicles are divided into diesel vehicles directly injecting fuel into a combustion chamber and gasoline vehicles injecting fuel into intake passage or intake manifold and supplying air-fuel mixture to a combustion chamber through intake valves.

In a case of the gasoline vehicle, the injected fuel is supplied to the combustion chamber through the intake valve after being sufficiently mixed with the air at the intake passage or the intake manifold. Therefore, fuel spray characteristics are little important.

In a case of the diesel vehicle, however, the fuel is directly injected into the combustion chamber through an injector and is burned therein. Therefore, it is hard to take a sufficient time for the fuel to be mixed with the air. Thus, fuel spray characteristics are very important in a case of the diesel vehicle, and have a great effect on combustion characteristics.

FIG. 1 is a partial cross-sectional view of an injector used in a diesel engine.

As shown in FIG. 1, a needle 30 is inserted in a housing 10, and a plurality of nozzle holes 40 for communicating an inside of the housing 10 with an outside thereof is formed at a lower end of the housing 10.

The needle 30 moves in the housing 10 reciprocally and selectively communicates a fuel passage formed at an interior circumference of the housing 10 with the plurality of nozzle holes 40. That is, if the needle 30 contacts with a needle seat 20 formed at a lower portion of the housing 10 the fuel passage and the nozzle hole 40 are not communicated with each other, and if the needle 30 is parted from the needle seat 20 the fuel passage and the nozzle hole 40 are communicated with each other.

Recently, the number of nozzle holes 40 is increased and a diameter of the nozzle hole 40 is reduced so as to increase mixing rate of fuel and air. If the mixing rate of the fuel and the air is increased, there are merits that fuel economy may be improved and emission may be reduced, but there are drawbacks that soot may increase and utilization rate of air may be reduced at middle or high load condition since fuel sprays are overlapped due to strong swirl flow if the number of the nozzle holes 40 is increased.

FIG. 2 illustrates spraying shape of fuel injected by a conventional injector.

Compared with the spraying shape of the fuel shown in FIG. 2A, the spraying shape of the fuel shown in FIG. 2B is a spraying shape of the fuel injected through the nozzle holes 40 having larger numbers and smaller diameter. If the diameter of the nozzle hole 40 is small, pressure of the fuel passing through the nozzle hole 40 is high and fuel spray spreads widely in a combustion chamber. In addition, if the number of the nozzle holes 40 is large, space between fuel sprays becomes narrower. Therefore, the fuel spays may be easily overlapped and generation of soot may increase.

In addition, since penetration length of the fuel is shortened (referring to FIG. 3) instead of spreading the fuel spray widely, fuel economy and emission may be deteriorated at middle or high load condition.

Meanwhile, one of the factors deciding spraying characteristics of the injector for the diesel engine is K factor. As shown in FIG. 1, if an inlet diameter of the nozzle hole 40 is dᵢₙ and an outlet diameter of the nozzle hole 40 is dₒᵤₜ, the K factor is represented as follows:

K factor=(dᵢₙ−dₒᵤₜ)/10

FIG. 3 illustrates spraying shape and penetration length according to K factor.

As shown in FIG. 3, if the K factor is small the penetration length is shortened but the fuel spray spreads widely, and if the K factor is large penetration length increases but the fuel spray becomes narrower. That is, if the fuel is injected through the nozzle hole having small K factor, the air and the fuel are mixed well and emission is reduced at low load condition but the penetration length is shortened and output is reduced at high load condition where a lot of fuel should be injected. In addition, if the number of the nozzle holes having small K factor increases, the fuel spray has high possibilities of being overlapped.

On the contrary, if the K factor of the nozzle is large, the penetration length becomes longer but the fuel spray becomes narrower. Therefore, output may increase but mixing of the air and the fuel is deteriorated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an injector for vehicles having advantages of reducing emission at a partial load condition and obtaining sufficient output at a full load condition as a consequence of injecting fuel through a plurality of nozzle holes having different K factors.

In addition, various aspects of the present invention has been made in an effort to provide an injector for vehicles having further advantages of reducing generation of soot by preventing fuel sprays from being overlapped even if the number of nozzle holes is increased.

An injector for vehicles according to various aspects of the present invention may include a housing of cylindrical shape, a plurality of nozzle holes communicating an inside of the housing with an outside thereof at a lower end of the housing, and a needle adapted to move reciprocally in the housing, and selectively opening or closing the nozzle hole, wherein the plurality of nozzle holes has a plurality of K factors.

The plurality of nozzle holes may include a first nozzle hole having a first K factor, and a second nozzle hole having a second K factor different from the first K factor.

The first nozzle hole and the second nozzle hole may be alternately formed.

The first nozzle hole and the second nozzle hole may be formed at an exterior circumference of the housing having the same radius.

An injector for vehicles according to other aspects of the present invention may be provided with a plurality of nozzle holes through which fuel is injected. wherein the first nozzle hole and the second nozzle hole are formed at an exterior circumference of a housing having the same radius. The plurality of nozzle holes may include a first nozzle hole having a first K factor and a second nozzle hole having a second K factor different from the first K factor. The first nozzle hole and the second nozzle hole may be formed at an exterior circumference of a housing having the same radius.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a partial cross-sectional view of an exemplary injector used in a diesel engine.

FIG. 2 illustrates spraying shape of fuel injected by a conventional injector.

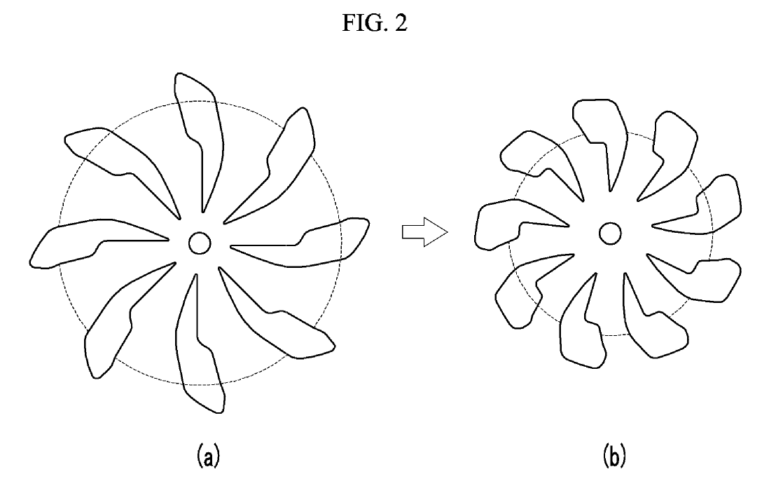

FIG. 3 illustrates spraying shape and penetration length according to K factor.

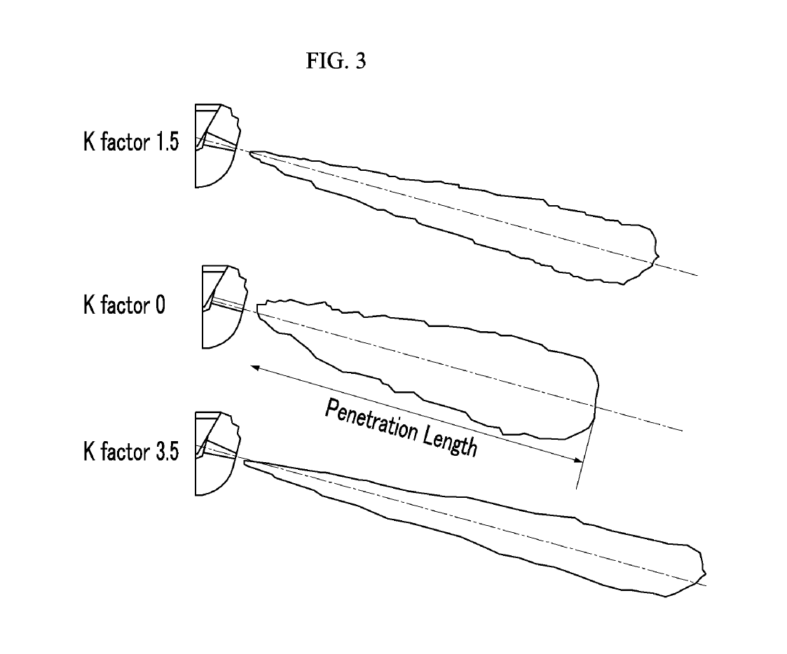

FIG. 4 illustrates an arrangement of nozzle holes in an exemplary injector according to the present invention.

FIG. 5 illustrates fuel spraying shape of a conventional injector and fuel spraying shape of an injector according to various embodiments of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Certain aspects of an injector according to the present invention are similar to that of a conventional injector. Therefore, the same reference numerals are used for representing the same constituent elements.

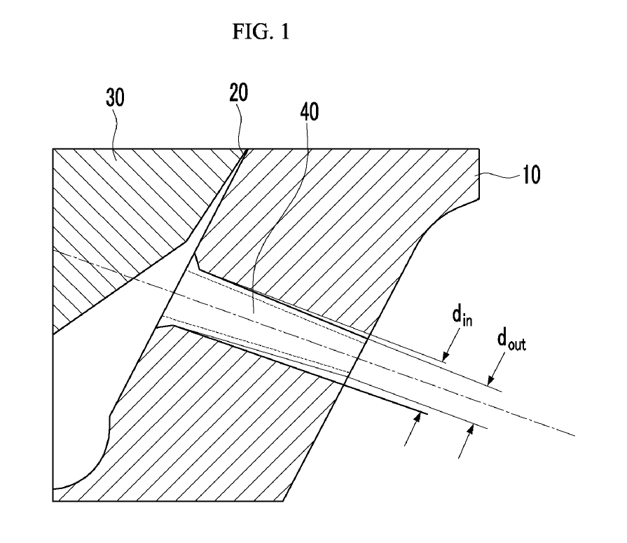

As shown in FIG. 1, the injector according to various embodiments of the present invention includes a needle 30 disposed in a housing 10, and the needle 30 is adapted to move in the housing 10 reciprocally. In order to move the needle 30 reciprocally, an electromagnet is provided at an upper portion of the housing 10. If current is applied to the electromagnet the needle 30 moves upwardly, and if current is not applied to the electromagnet the needle 30 moves downwardly and contacts with a needle seat 20.

In addition, a fuel passage is formed in the housing 10. The fuel passage is always communicated with a fuel supply passage provided at an outside of the injector so as to receive fuel.

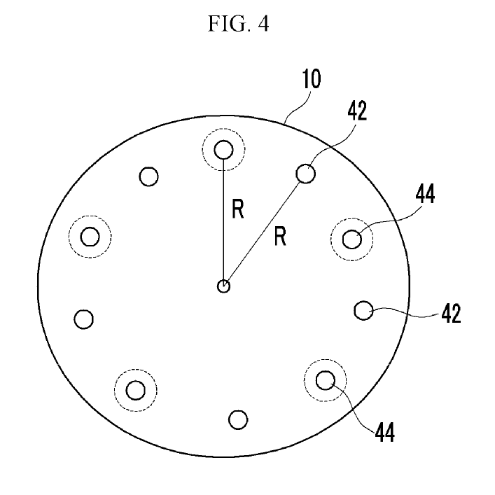

FIG. 4 illustrates arrangement of nozzle holes in an injector according to various embodiments of the present invention.

As shown in FIG. 4, a plurality of first and second nozzle holes 42 and 44 is formed at the housing 10 under the needle seat 20. The first and second nozzle holes 42 and 44 are selectively communicated with the fuel passage by reciprocal motion of the needle 30. Therefore, the fuel in the fuel passage is selectively injected to a combustion chamber through the first and second nozzle holes 42 and 44.

In order for the fuel passing through the first and second nozzle holes 42 and 44 to have different spraying characteristics, K factors of the first and second nozzle holes 42 and 44 are different from each other. That is, the first nozzle hole 42 has a first K factor, the second nozzle hole 44 has a second K factor, and the first K factor and the second K factor are different. For example, the first K factor is smaller than the second K factor. In this case, the fuel injected through the first nozzle hole 42 has short penetration length but spreads widely. Therefore, the fuel is mixed with air well. Thus, the fuel injected through the first nozzle hole 42 may improve emission at a partial load condition. In addition, the fuel injected through the second nozzle hole 44 has long penetration length, and thereby sufficient output may be obtained at middle load condition or high load condition.

In addition, the first and second nozzle holes 42 and 44 are disposed alternately. Further, the first and second nozzle holes 42 and 44 are disposed at an exterior circumference of the housing 10 having the same radius R. If the first and second nozzle holes 42 and 44 are disposed at the exterior circumference of the housing 10 having the same radius R, a distance from the needle seat 20 to the first nozzle hole 42 is the same as that from the needle seat 20 to the second nozzle hole 44. This means that moving distances of the fuel for passing through the first and second nozzle holes 42 and 44 are the same. Therefore, fuel amount passing through the first nozzle hole 42 is almost the same as that passing through the second nozzle hole 44. Therefore, effects of the injector according to various embodiments of the present invention are produced at an entire driving condition.

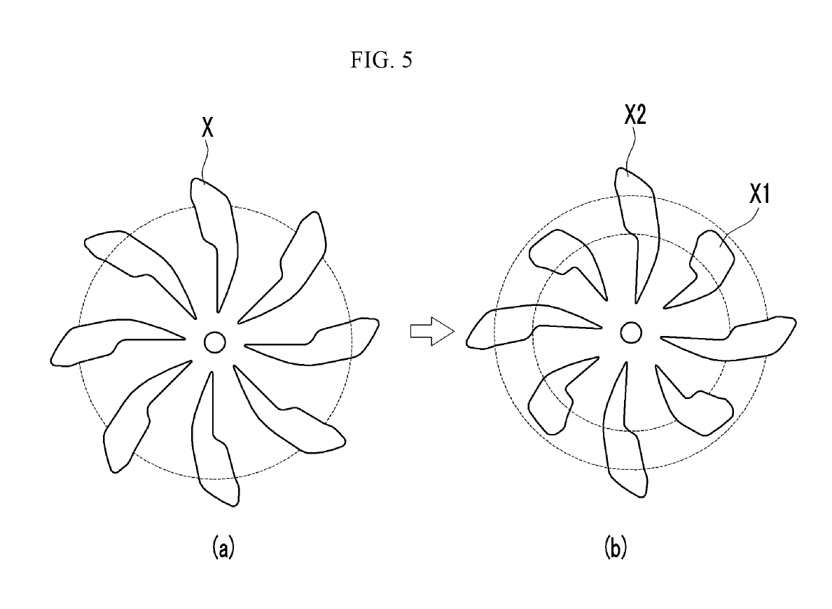

FIG. 5A illustrates fuel spray X when the fuel is injected through a conventional injector having one K factor, and FIG. 5B illustrates fuel sprays X1 and X2 when the fuel is injected through the injector according to various embodiments of the present invention having two K factors.

If the fuel is injected through a conventional injector, a plurality of fuel sprays X has almost the same shape. Therefore, the fuel spray X spreads widely and may be overlapped with each other in a case that the fuel is injected through a conventional injector having small K factor. On the contrary, spaces between the fuel sprays X may be large in a case that the fuel is injected through a conventional injector having large K factor. Therefore, utilization rate of air may be lowered.

However, a first fuel spray X1 injected through the nozzle hole having small K factor spreads widely and increases utilization rate of air, and a second fuel spray X2 injected through the nozzle hole having large K factor is stretched long and generates sufficient output in a case that the fuel is injected through the injector according to various embodiments of the present invention. In addition, since the first fuel spray and the second fuel spray spread toward different portions of the combustion chamber, the first fuel spray and the second fuel spray are not overlapped with each other.

Therefore, generation of soot may be reduced, utilization rate of air and mixing rate of air and fuel may increase, and fuel economy may be improved according to various embodiments of the present invention.

As described above, since fuel sprays injected through a plurality of nozzle holes having different K factors spreads toward different portions of a combustion chamber, utilization rate of air may increase according to various embodiments of the present invention. Therefore, emission may be reduced, fuel economy may be improved, and sufficient output may be produced.

Since fuel sprays are not overlapped with each other, generation of soot may be prevented.

For convenience in explanation and accurate definition in the appended claims, the terms upper and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An injector for vehicles, comprising:
a housing having a cylindrical shape;
a plurality of nozzle holes communicating an inside of the housing with an outside thereof at a lower end of the housing; and
a needle reciprocally moveable in the housing for selectively opening or closing the nozzle holes;
wherein the plurality of nozzle holes have a plurality of K factors.

2. The injector of claim 1, wherein the plurality of nozzle holes comprises:
a first nozzle hole having a first K factor; and
a second nozzle hole having a second K factor different from the first K factor.

3. The injector of claim 2, wherein the first nozzle hole and the second nozzle hole are alternately formed.

4. The injector of claim 2, wherein the first nozzle hole and the second nozzle hole are formed along an exterior circumference of the housing having the same radius.

5. An injector for vehicles comprising:
a plurality of nozzle holes through which fuel is injected;
wherein the plurality of nozzle holes include a first nozzle hole having a first K factor and a second nozzle hole having a second K factor different from the first K factor; and
wherein the first nozzle hole and the second nozzle hole are formed along an exterior circumference of a housing having the same radius.
